(19) United States
(12) Patent Application Publication
(10) Pub. No.: US 2016/0105517 A1
(43) Pub. Date: Apr. 14, 2016

(54) E-Commerce System and Method for Producing, Storing, Managing and Marketing Finished and Unfinished Creative Works

(71) Applicants: Alexander Pis, Stupava (SK); Fedor Pis, Stupava (SK)

(72) Inventors: Alexander Pis, Stupava (SK); Fedor Pis, Stupava (SK)

(21) Appl. No.: 14/864,230

(22) Filed: Sep. 24, 2015

Related U.S. Application Data
(60) Provisional application No. 62/061,286, filed on Oct. 8, 2014.

(51) Int. Cl. H04L 29/08

(52) U.S. Cl. CPC H04L 67/22; H04L 67/02; H04L 67/306

(57) ABSTRACT

A web enabled e-commerce computer system and method for creating, managing, and marketing collaborative works is disclosed. The system allows registered users to upload their unfinished creative works in a digital electronic file format and allows access to the files by other registered users in order to add, modify, or rearrange the composition of the files in order to transform the unfinished creative work into a marketable finished work. The system tracks the relative contributions of the other registered users and when the work is finished the system calculates the respective ownership shares of each of the users based upon their respective contributions.

### BACKGROUND

The present disclosure pertains generally to the field of database management systems, and more particularly to web portal based computer software systems for facilitating the collaborative use of ideas, concepts, designs, and other creative works of authors, artists, composers, musicians, writers, inventors, architects, software developers, and others at remote locations, and providing a web enabled e-commerce marketplace for their sale and/or distribution.

### SUMMARY

The present disclosure provides, in certain aspects, unique devices, methods and systems for remote collaboration of skilled creators. In the past, web enabled platforms implementing crowdsourcing techniques have been used to subdivide tedious work tasks or to fund-raise startup companies and charities. Crowdsourcing combines the efforts of numerous self-identified volunteers or part-time workers, where each contributor of their own initiative adds a small portion to the greater result. Crowdsourcing is distinguished from outsourcing in that the work comes from an undefined public rather than being commissioned from a specific, named group. Typically, the aim of the crowdsourcing platform is to obtain specific predefined tasks or services by soliciting contributions from a large group of people in an online community. In contrast, the present disclosure provides an online platform for people with creative skills to remotely collaborate to produce non-specific and not predefined joint creative works as wide as their imaginations can take them.

In one exemplary embodiment, there is provided an on-line creative collaborative idea platform, where one is able to produce, save and offer their ideas for sale. Sometimes individuals simply forget, lose or save their idea in their respective workspace, thinking they will come back to it tomorrow but never do. Other times, the creator may make a number of attempts to complete the work but never finishes it because of a lack of further creative inspiration, loss of motivation, other distractions, and various other reasons. The idea languishes, gets lost, or otherwise never gets implemented. The web enabled platform of the present disclosure gives these individuals a chance to properly store and register the unfinished work or idea, enhance and/or improve it via contributions from other individuals, complete it, and finally sell it with equitable remuneration to the joint authors.

Further forms, objects, features, aspects, benefits, advantages, and embodiments of the present disclosure will become apparent from the detailed description and drawings included herein.

### BRIEF DESCRIPTION OF THE DRAWINGS

FIG. 1 illustrates one embodiment a user accessing a host website of the web enabled e-commerce computer system and method of the present disclosure.

FIG. 2 is a flow diagram of the computer system and method of the present disclosure shown in FIG. 1.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is described and shown in great detail, although it will be apparent to those skilled in the relevant art that some features that are not relevant to the present invention may not be shown for the sake of clarity.

Referring also to the drawings, in one example the original author may be using a popular website accessible software product such as for example Ableton Live™ (www.ableton.com) to produce a musical track. The author produces the first couple of bars for the song track but then either gets stuck, thinks the idea is not worth continuing or simply decides to stop and come back to it later. From the many, let's say for example 200, saved projects in the Ableton Live™ folder you might eventually complete your favorite 30 song tracks. However, the web platform of the present disclosure would enable you to upload your other unfinished record tracks and would thus serve as a permanent stored database. Each track may be assigned with a special ID that would encode the original author's username as well as the time of the upload. The track may be uploaded in two separate manners, either as a finished product, where it would be offered directly for sale to other users of the platform (other producers, commercial companies etc), or as an unfinished product, where it would be available for sharing and reworking with others that are willing to develop the product forward or mix it with their own ideas, master it and label it as a finished piece. One may also have the option of uploading the product both ways so that it can be bought the way it is, or it can be freely reworked by others and sold on the joint authors' agreed basis.

If the joint authors do not reach a decision upon themselves as to how much of the final product has been contributed by every contributor, and thus preventing the marketing of the product, the website platform host would step in as the arbitrator to ensure that the final product would go on sale and profits would be equitably distributed among the joint authors according to their relative contributions. By registering on the website platform a user would give consent that their author's rights are tracked with others that have shared the idea or work in a way that would make all co-authors shareholders, such as for example based on an ownership division algorithm that would calculate the amount of time each individual contribution is used within the final product. For a literary work, the algorithm could for example be based in whole or in part upon the number of words contributed to the final product. The algorithm would also assign the website host a predefined percentage share (e.g., 50%) of the ownership rights in the final product. The web platform host will thus ensure that the relative contributions of all participating authors are given equitable consideration during the production phase as well as protecting their ownership rights and respective cash flows in the case that the finished product is sold to a third party.

The situation may also occur that a disc jockey or another artist significantly improves the final product such as by rearranging some pre-existing components of the final piece, making his/her share difficult to calculate. In this case, which is only one of many possible such examples, the platform host will notify and bring all the joint authors together, so that they may have an opportunity to determine their respective ownership shares amicably. If they reach an agreement, only then would the work be moved to the registry of finished products and be made available for sale. If, however, they do not reach an agreement the platform host (which has a predetermined fixed percentage ownership of rights in all registered works) will decide the final share of all authors, based on the platform host's best industry knowledge as incorporated in its ownership division algorithm. The platform host could also set the sales price for the finished product.

For further example, consider the situation where the original uploader's consent is needed to place a product into the finished products registry. Another user/contributor that reworked the original may have improved the quality of it significantly, however the consent of the original author is needed to place the reworked product into the finished products registry, so that it is eligible for sale. The idea of having the web platform host possessing a predetermined fixed ownership (such as for example 50%) and decision right will ensure that none of the products will stagnate, such as might occur for further example in the scenario that the original author uploader does not log in again after his original product has been initially uploaded. The web platform host is then able to step in and make the ownership division decision so that all the contributors benefit. The original author, however, will still get paid according to what the web platform host's algorithm has determined his/her contributive share of the track was, so that everyone is at least better off. In order to further incentivize original authors to upload their unfinished works, the ownership division algorithm could be formulated to provide the original author with a minimum fixed ownership percentage in the finished product, such as 10 or 20 percent, so that the original authors will know that no matter how much their original contribution is reworked they will still have a significant ownership share in the final product.

In one further preferred aspect, the collaborative idea platform of the present disclosure may provide an on-line platform for many separately categorized types of creative works such as for example music arts, literature, utilitarian and ornamental designs, and architecture. Each of these general categories or fields of work may themselves be further broken down into more specialized sub-categories. In the case of literature products, software in which the literary work has been created may be any open source text processor based software, or alternatively a preselected in-house software developed specifically for the on-line platform to write poetry, scenarios, novels, songs, etc. The revenue sharing and ownership principles on co-authorship may be determined similarly for all categories of works, or specialized algorithms may be employed with particular categories of works in order to account for the particular practices, customs, and expectations of different classes of creators in their individual fields.

In order to be able to use and convert various uploaded ideas and works not necessarily created in the same software program by our registered clients, the on-line platform of the present disclosure may be configured to convert products of the most widespread and commonly used software programs in each art industry (like Ableton Live™ into Reason™ and back, in music production for example). As these software programs are not usually open sourced, but instead are private property of certain software development companies, permissions would need to be obtained with various major software houses in order to be able to convert works stored on or via their websites to other major formats. This would enable customers or users to use whatever software they are used to, and would also be accounted for by an appropriate algorithm when calculating each individual share in the final product by measuring and comparing the relative input of each client, which would sometimes be made in different software.

According to one further aspect, a user registry may be provided that contains records associated with potential contributors. Access to the user registry can be limited by any suitable means for access control, including authentication protocols, encryption, user-specific filters, etc. An original author may for example be permitted to control access to his/her unfinished work files to any or all users in the user registry.

In a yet further aspect of the present disclosure, the web platform host may send a solicitation communication to third party media application software houses (such as music production software houses like Ableton, Reason, etc.), which software we would like to be supported by the webplatform host, in order to be able to convert uploaded products. The solicitation letter may for example include the following points:
1. The host platform's intention is NOT to prefer any particular application software, rather it is intended that users are given the opportunity to use the particular software they are already familiar with, or one they would decide to acquire familiarity with;
2. The host platform believes its platform and those application software listed as convertible by the host platform will help the platform's users in their decision making, as to which software they would acquire, or will continue to use;
3. It would be in the interest of a particular software developer to allow its software to be listed on the host platform, as it would enhance its chances to be sold or upgraded by the host platform's user community. It may be viewed as a disadvantage by the user community if the software cannot be converted for the purposes of the host platform;
4. Once the approval is granted by the third party software company for permission to be able to convert files from one software application into another, the approval agreement will state the conditions under which the platform host would be eligible to use it.
5. The platform host would then develop the converter machine at costs agreed and shared according to covenants of the approval.
6. Approval contracts shall have a binding license clause on any future updates in case it is needed for the prompt converting function of the host platform.

Once consent of the desired media production software houses is obtained, their software applications may be incorporated into the host's platform. In its most basic form, the on-line collaborative development platform may be at least initially implemented in only one or two categories, such as for example music and literature, or whichever categories are the most easy to develop and build libraries of unfinished works. The platform could then later be further expanded into other areas such as science, architecture, etc.

Once the website platform is fully functional and visited by customers, each category of creative work (e.g., Musical, Literature, Design) will have its own sales and support teams. This arrangement allows for more specialized business negotiations with people within each specific industry on behalf of the platform's host and, for example, certain targeted users (e.g., VIP clients based on past revenue production). For example, in a situation where an interesting idea or script for a movie has been created by a registered user the platform's host might decide, instead of or in addition to the standard method of listing the product for sale in the finished products registry, to proactively search for interested movie producers and/or movie directors, thus achieving better overall results for the platform host and the author(s).

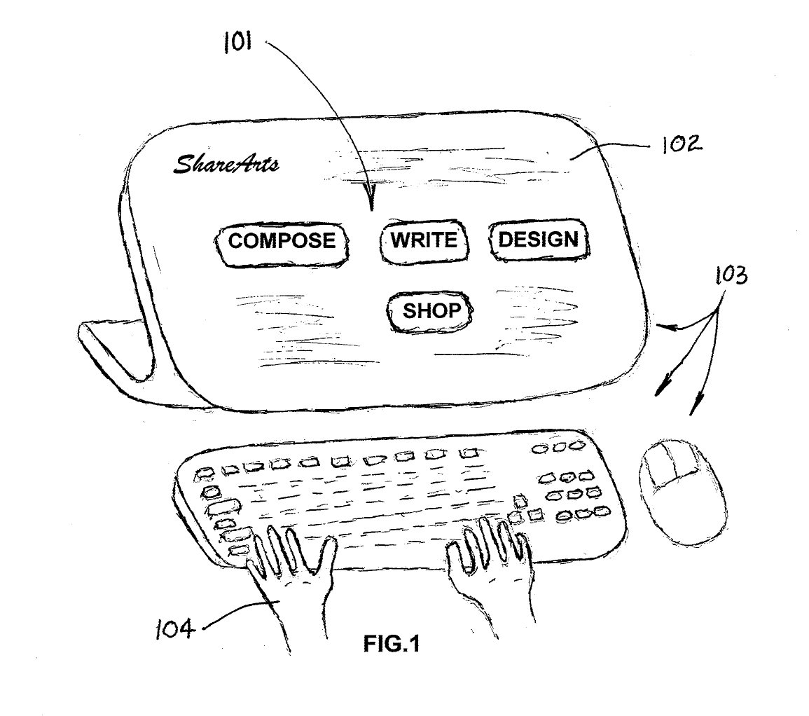

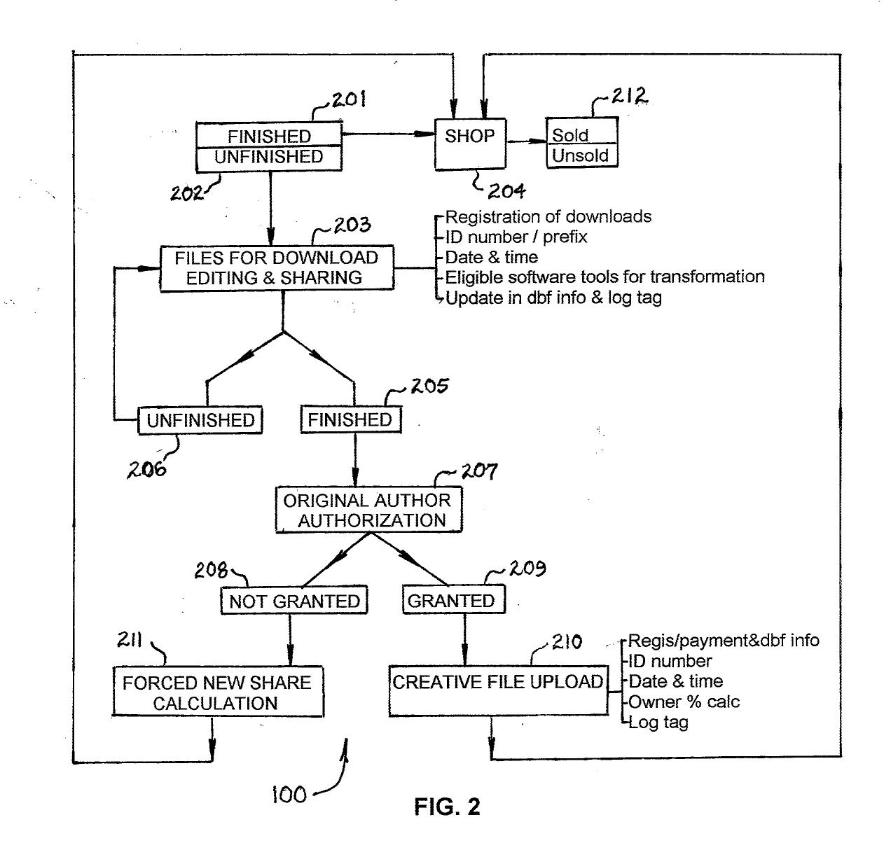

The operation of the on-line platform (e.g., website) of the system 100 of the present disclosure may be more particularly described as follows:
1. Upon entering the website 101 of the system depicted on the display 102 of computer 103 shown in FIG. 1, a user 104 would see four clickable buttons having for example the words: COMPOSE, WRITE, DESIGN, SHOP. In order to access the COMPOSE, WRITE, and DESIGN areas of the website the user 104 would need to be logged in as a registered user, such as for example by providing username and password information.
2. If the registered user chooses COMPOSE (i.e, corresponding to an audio music track), all convertible software available shows up, so one can decide to upload, download or create a particular work in any particular third party's software (in this case, music media software such as for example Ableton™, Reason™, Logic Pro™, etc.) or the website's software application in the event no conversion is required.
3. Once she/he decides on software and on either uploading, downloading, or creating a new file for their work, she/he is requested to register and accept terms and conditions of the host platform. Alternatively, the registration step may take place before the user selects the particular software application.
4. There is a possibility within each upload for the registered user to click either a button for uploading a final product, including a sales price tag, or a button for uploading an unfinished product, or both (see boxes 201 and 202 in FIG. 2). In addition, she/he will need to select appropriate categories provided regarding the type of file he wants to work with (drums, base, vocals, guitars etc., plus genre (pop, rock, electronica, rap etc.)
5. When downloading (see box 203 in FIG. 2), the registered user will have a possibility to check in the sorting criteria of what he is interested in (like genre, musical instruments, etc.) listen to the file first and then he may choose to buy the product in the SHOP section 204, (in case the price tag is there—it is automatically a finished product, marked such by an author/authors) or download it for further enhancement (when the price is missing, ie unfinished products).
6. While listening to posted files, one would have the possibility to click likes, (such as on a volume based scale −5 to +5), and to value any other interesting parameters of the file (like rhythm, melody, composition, beat, etc.). The user 104 would also be able to check the file as his/her's favourite for further enhanced search and use.
7. With each upload an individual ID (identification number) for that file is created containing information such as for example who has placed it and when. That ID goes with the file through the editing/enriching process, and is updated for another co-author's information and the additional author(s) respective profit shares.
8. In the case of a download, a tag is created assignable to a specific ID, identifying who has downloaded the file and when.
9. When a modified file is uploaded again it runs through an algorithm test (at ORIGINAL AUTHOR AUTHORIZATION box 207) that calculates the new share distribution among authors, and a new ownership and revenue distribution proposal is automatically sent to all authors. In addition, it may further undergo an originality test. If it successfully passes all tests, it may then be marked as finished product (see box 205) by all authors by agreeing on a price tag amount that shall be approved by all authors. If it is not marked finished and a forced calculation is not requested, the work remains unfinished (see box 206) and continues to be available for editing and sharing (box 203). If finished and consent is granted, it is offered for sale an ID number goes out (along with other associated info as shown in the CREATIVE FILE UPLOAD box 210) and is stored in the FOR SALE products database accessed from the SHOP button). In the event the authors do not reach agreement (NOT GRANTED box 208) either on price or ownership share distribution, they request the owner of the on-line collaboration platform for a final and binding verdict (see FORCED NEW SHARE CALCULATION box 211).
   In the SHOP section of the website:

A standard sales contract, with terms and conditions is provided on the web-site, for a purchaser to agree to in the situation where a finished product is sold (box 212).

The web platform host will develop a sales software system (for example, similar to Apple iTunes™), that will offer finished products for sale at the price determined by the authors. The the platform host will have an agreed percentage, such as for example 50%, of the ownership and revenues, the remainder being split with the creators/authors according to their respective participating shares.

The system will keep track of all registered user sales and will rate each registered user's success in monetary terms, as well as number of works sold and unsold (box 212). The system will record all likes, per work and author, so that it may over time distinguish successful authors. The platform would be able to select more successful users as VIP clients with special treatment, such as better support features, sales incentives, legal and industry advice, special joint promotions, etc.

In the WRITE section of the website:

The host platform would either develop or purchase a software application that would be easy to use to write novels, scenarios etc. Current examples of such literary production software applications include LibreOffice Writer™, Sigi™, TreeSheets™, among many. A desirable feature for such an application would be one that would be easily convertible to other commonly used text processors. After clicking the “WRITE” button, the following options would appear: poetry, novel, play, scenario, with a help on brief set of characters, locations with possibility of photos attachments around the text to unfold, with functions of making easy dialogues by clicking the character after each direct speech etc. The system 100 would then work the same as in the case of clicking and using COMPOSE for music files.

While the invention of the present disclosure has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A web enabled e-commerce computer system for creating, managing, and marketing collaborative works, comprising:
a computing device;
a plurality of unfinished creative work files, each of said files containing information corresponding to a creative unfinished work of a registered user in a digital electronic format;
a computer software program stored in non-transitory computer readable memory in said computing device that is configured to perform operations, said computer software program including
registering users for login authentication and access by a user identification;
uploading one or more said unfinished creative work files in a digital electronic format;
organizing and storing said files into a plurality of databases corresponding to predefined categories of creative works;
converting said unfinished creative work files into a production application software program suited for further processing the creative work;
allowing access to said files by other registered users in order to add, modify, or rearrange the composition of said files;
tracking the contributions of said other registered users to said unfinished creative work files; and
determining the relative contributions of each user.

2. A method for creating, managing, and marketing collaborative works by anonymous remote users employing a web enabled host platform, comprising the steps of:
registering users for login authentication and access to a web enabled host platform by a user identifcation;
uploading one or more said unfinished creative work files in a digital electronic format accessible via said web enabled host platform;
organizing and storing said files into a plurality of databases corresponding to predefined categories of creative works;
converting said unfinished creative work files into a production application software program suited for further processing the creative work;
allowing access to said files by other registered users in order to add, modify, or rearrange the composition of said files;
tracking the contributions of said other registered users to said unfinished creative work files; and
determining the relative contributions of each user by application of an ownership division algorithm.
